(19) United States
(12) Patent Application Publication
(10) Pub. No.: US 2024/0368313 A1
(43) Pub. Date: Nov. 7, 2024

(54) DETERMINING THE LIQUID COMPOSITION IN A LOOP SLURRY POLYMERIZATION REACTOR

(71) Applicant: Chevron Phillips Chemical Company LP, The Woodlands, TX (US)

(72) Inventors: Qing Yang, Bartlesville, OK (US); Joel A. Mutchler, Porter, TX (US); Eric J. Netemeyer, Kingwood, TX (US); Mitchell D. Refvik, Bartlesville, OK (US); Carlton E. Ash, Owasso, OK (US)

(21) Appl. No.: 18/313,080

(22) Filed: May 5, 2023

(51) Int. Cl. C08F 2/01

(52) U.S. Cl. CPC C08F 2/01

(57) ABSTRACT

In processes and systems having a loop slurry polymerization reactor, a sample separator can be operated at low pressure conditions that provide better separation of liquids from a sample of the reactor effluent, so that measurement of the composition of the vapor phase recovered from the sample separator can more accurately reflect the composition of the liquid in the loop slurry polymerization reactor compared to the composition of the vapor phase recovered from the product separator.

### FIELD OF THE DISCLOSURE

The present disclosure generally relates to loop slurry polymerization reactors, and more particularly, to determining the liquid composition in loop slurry polymerization reactors.

### BACKGROUND

Loop slurry polymerization reactors circulate a reaction medium containing a liquid diluent, olefin monomer(s), and catalyst under polymerization conditions to form solid polymer particles in the reaction medium. The polymerization conditions are selected and controlled to produce particular properties of the solid polymer particles, e.g., to meet a customer's product specification. Operating conditions such as temperature, pressure, and flow rate of reaction components into and out of the reactor can be measured with sensors connected to the reactor. The reactor can then be controlled based on the measurements in order to control the polymerization conditions that produce particular properties of the solid polymer particles. Another operating condition that can help control polymer properties is the composition of the liquid in the reaction medium. Measuring the concentration of components in the liquid in the reaction medium during reactor operation can be challenging. As an alternative, the composition of the liquid in a reactor effluent withdrawn from a loop slurry polymerization reactor can be measured in order to determine the composition of the liquid in the reaction medium in the loop slurry polymerization reactor. However, it has been found that the equipment used for in-line measurement fouls and fails.

There is ongoing need to accurately determine the liquid composition in the loop slurry polymerization reactor.

### SUMMARY

Disclosed is a process including: removing a reactor effluent from a loop slurry polymerization reactor; splitting the reactor effluent into a first portion and a second portion; flowing the first portion of the reactor effluent to a product separator; separating, in the product separator, the first portion of the reactor effluent into a vapor product portion including unreacted olefin monomers and diluent and a solid product portion including solid polymer; flowing the second portion of the reactor effluent of the loop slurry polymerization reactor to a reactor effluent vapor composition measurement system; separating, in the reactor effluent vapor composition measurement system, the second portion into a vapor sample portion and a solid sample portion; and determining a concentration of a gas component in at least a portion of the vapor sample portion.

Disclosed is a polymerization system including: a loop slurry polymerization reactor configured to polymerize olefin monomers to form a solid polymer; a polymer product stream connected to an outlet of the loop slurry polymerization reactor; a product separator coupled to the polymer product stream; and a reactor effluent vapor composition measurement system coupled to the polymer product stream at a first location in the polymer product stream that is upstream of the product separator with respect to a main direction of flow of reactor effluent through the polymer product stream.

Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1 illustrates a schematic diagram of a polymerization system that splits the reactor effluent for flow of a portion to the reactor effluent vapor composition measurement system upstream of the product separator.

FIG. 2 illustrates a schematic diagram of a polymerization system that splits the reactor effluent for flow of a portion to the reactor effluent vapor composition measurement system upstream of the product separator and upstream of the flashline heater.

FIG. 3 illustrates a schematic diagram of a polymerization system that splits the reactor effluent for flow of a portion to the reactor effluent vapor composition measurement system between two segments of a flashline heater.

### DETAILED DESCRIPTION

“High pressure” when used herein with reference to an operating pressure of a product separator includes pressures in a range of from 100 psig to 400 psig (0.861 MPag to 2.758 MPag).

“Low pressure” when used herein with reference to an operating pressure of a sample separator and any low-pressure product separator includes pressures in a range of from 0 psig to 45 psig (0 MPag to 0.310 MPag).

“Split”, “splitting”, and their variants when used herein refers to the division of a composition into to two portions or parts, where each portion or part has the same composition as the other portion(s) or part(s).

The term “stream” as used herein refers to a composition in a gas phase, in a liquid phase, in a solid phase, or any combination of phases. The term “stream” can additionally refer to and imply associated equipment, such as conduit, line, and pipe that is used to move the composition from one location to another. Alternatively, the term “stream” refers only to the composition contained within the equipment.

To overcome challenges associated with in-line measurement of the liquid in reactor effluent of a loop slurry polymerization reactor, it has been proposed to convert the liquid of the reactor effluent to vapor and to measure the concentration of components in the vapor, assuming that the vapor composition recovered from the reactor effluent can accurately represent the liquid composition in the reactor.

Product separators in polymerization systems having loop slurry polymerization reactors can recover a vapor phase from a reactor effluent. The vapor phase from the product separator can be analyzed for component composition, in accordance with the assumption that the vapor composition accurately reflects the liquid composition in the loop slurry polymerization reactor. It has been found that when the product separator that receives the reactor effluent is a high pressure separation, not all liquid components of the reactor effluent adequately separate from the solid polymer into the vapor phase. Thus, measurement of the composition of the vapor phase recovered from the high pressure flash vessel does not accurately reflect the liquid composition in the loop slurry reactor because at least some of the less volatile components (e.g., diluent such as isobutane, comonomer such as 1-butene or 1-hexene) can remain with the solid polymer after high pressure separation.

The disclosed processes and polymerization systems include a sample separator operated at low pressure conditions that provides better separation of liquids from the solid polymer in the reactor effluent, so that measurement of the composition of the vapor phase recovered from the sample separator can more accurately reflect the composition of the liquid in the loop slurry polymerization reactor. The sample separator can be implemented when the first or only vessel of the product separator is a low pressure separator or a high pressure separator, making accuracy of the vapor phase composition measurement independent of the operating pressure of the product separator for the reactor effluent and independent whether the vapor recovered from the product separator is at low pressure or at a high pressure.

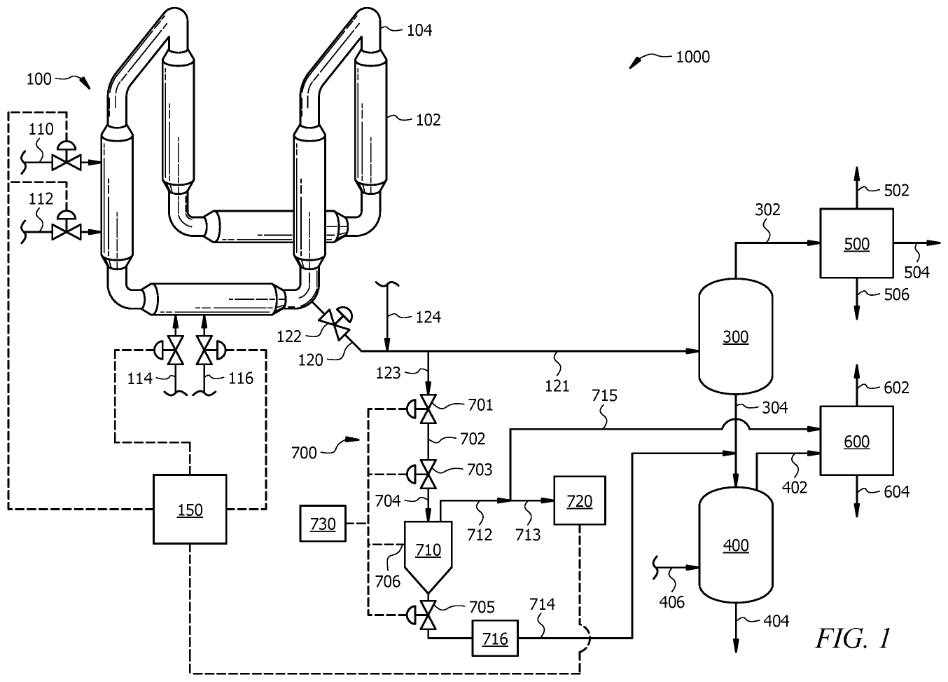

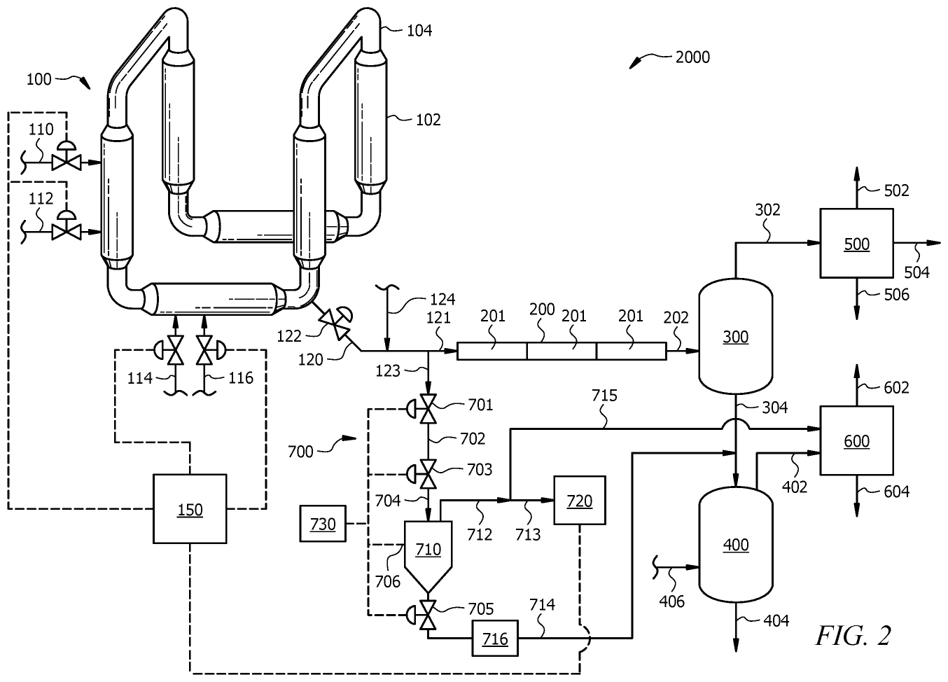

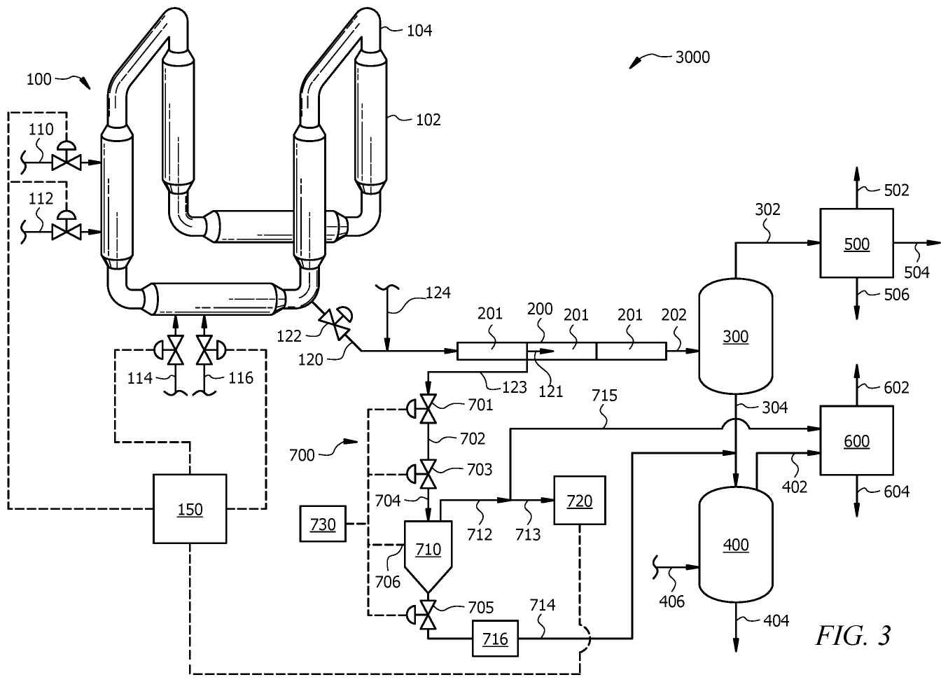

FIGS. 1, 2, and 3 illustrate schematic diagrams of polymerization systems 1000, 2000, and 3000. The polymerization system 1000 in FIG. 1 includes a loop slurry polymerization reactor 100, a reactor controller 150, a product separator 300, a purge column 400, a monomer/diluent recovery unit (MDRU) 500, a diluent/nitrogen recovery unit (DNRU) 600, and a reactor effluent vapor composition measurement system 700. The polymerization systems 2000 and 3000 in FIGS. 2 and 3 include the loop slurry polymerization reactor 100, the reactor controller 150, a flashline heater 200, the product separator 300, the purge column 400, the monomer/diluent recovery unit (MDRU) 500, the diluent/nitrogen recovery unit (DNRU) 600, and the reactor effluent vapor composition measurement system 700.

The following discussion is made with reference to FIGS. 1, 2, and 3, as applicable. For example, FIG. 1 illustrates a schematic diagram of a polymerization system 1000 that splits the reactor effluent for flow of a portion to the reactor effluent vapor composition measurement system 700 upstream of the product separator 300, and the polymerization system 1000 does not have a flashline heater 200. FIG. 2 illustrates a schematic diagram of a polymerization system 2000 that splits the reactor effluent for flow of a portion to the reactor effluent vapor composition measurement system 700 upstream of the product separator 300 and upstream of the flashline heater 200. FIG. 3 illustrates a schematic diagram of a polymerization system 3000 that splits the reactor effluent for flow of a portion to the reactor effluent vapor composition measurement system 700 between two segments 201 of the flashline heater 200.

Generally, the loop slurry polymerization reactor 100 is configured to polymerize olefin monomers (e.g., ethylene, 1-butene, 1-hexene, or combinations thereof) in presence of a catalyst to form a solid polymer. A polymer product stream 120 is connected to an outlet of the loop slurry polymerization reactor 100, and a product separator 300 is coupled to the polymer product stream 120 (e.g., in some aspects, via a flashline heater 200 as described herein). The reactor effluent vapor composition measurement system 700 is coupled to the polymer product stream 120 at a location in the polymer product stream 120 that is upstream of the product separator 300 with respect to a flow of reactor effluent (e.g., in the main effluent flow direction) through the polymer product stream 120. Each of the components of the systems 1000, 2000, and 3000 are described in more detail herein.

The loop slurry polymerization reactor 100 can include one or more loop slurry polymerization reactors. When one loop slurry polymerization reactor is utilized, the loop slurry polymerization reactor 100 can be used as a single reactor, or in series with other loop slurry polymerization reactor(s) and/or other types of polymerization reactors such as gas-phase reactors (also known as fluidized bed reactors), autoclave reactors, or combinations thereof. When more than one polymerization reactor is utilized in any embodiment that includes the loop slurry polymerization reactor 100, no polymerization reactor is located downstream of the loop slurry polymerization reactor 100 illustrated in FIGS. 1 to 3. When more than one polymerization reactor is utilized in any embodiment that includes the loop slurry polymerization reactor 100, the polymerization systems 1000, 2000, and 3000 can include a polymer transfer device configured to transfer the polymers resulting from the first polymerization reactor into the loop slurry polymerization reactor 100. The desired polymerization conditions in one of the reactors can be different from the operating conditions of the other reactor(s). Alternatively, polymerization in multiple reactors can include the manual transfer of polymer from one reactor to the loop slurry polymerization reactor 100 for continued polymerization.

The loop slurry polymerization reactor 100 is configured to polymerize one or more olefin monomers and optionally comonomers (one or more than one comonomer) in a presence of a catalyst to produce homopolymers, copolymers, terpolymers, or combinations thereof. The loop slurry polymerization reactor 100 can comprise vertical and horizontal pipe segments 102 and pipe elbows 104. Each pipe segment 102 is connected to an elbow 104 on each end of the pipe segment 102.

Olefin monomer, diluent, catalyst, comonomer, or combinations thereof can be continuously fed to the loop slurry polymerization reactor 100. Olefin monomer can be fed via stream 110, which can have a control valve contained in the stream 110 for control of the flow of the olefin monomer into the loop slurry polymerization reactor 100. Olefin comonomer can be fed via stream 112, which can have a control valve contained in the stream 112 for control of the flow of the olefin comonomer into the loop slurry polymerization reactor 100. Diluent can be fed via stream 114, which can have a control valve contained in the stream 114 for control of the flow of the diluent into the loop slurry polymerization reactor 100. Catalyst can be fed via stream 116, which can have a control valve contained in the stream 116 for control of the flow of the catalyst into the loop slurry polymerization reactor 100.

The feed components described above can be circulated (e.g., by a pump) in the loop slurry polymerization reactor 100 continuously for a period of time to produce a polymer in the reaction medium.

Polymerization conditions that can be controlled for efficiency and to provide desired polymer properties can include temperature, pressure, and the concentrations of various feed components (e.g., olefin monomer, olefin comonomer, diluent, catalyst, or combinations thereof.

Polymerization temperature can affect catalyst productivity, polymer molecular weight, and molecular weight distribution. A suitable polymerization temperature can be any temperature below the de-polymerization (ceiling) temperature. In aspects, the polymerization temperature in the loop slurry polymerization reactor 100 includes temperatures in a range of from about 60° C. to about 121° C.; alternatively, from about 65° C. to about 110° C.; alternatively, from about 70° C. to about 90° C.; alternatively, from about 75° C. to about 85° C. Temperature is typically controlled by circulating a coolant in cooling jackets that surround each of the vertical segments 102 of the loop slurry polymerization reactor 100. Because polymerization reactions in the loop slurry polymerization reactor are generally exothermic, a coolant that flows through the cooling jackets absorbs heat from the vertical segments 102 to control the temperature of the loop slurry polymerization reactor 100. A condition of the coolant such as temperature and/or flow rate can be adjusted depending on the temperature of the reactor 100.

The polymerization pressure in the loop slurry polymerization reactor 100 can include pressures of less than 1000 psig. The pressure can be controlled by feeding olefin monomer, any olefin comonomer, diluent, and catalyst into the loop slurry polymerization reactor 100 at a pressure that is sufficient to maintain the polymerization pressure.

The concentrations of the feed components in the reaction medium can be controlled by control valves in the respective feed streams. The flow rate of olefin monomer in stream 110 can be controlled with the control valve in stream 110, the flow rate of any optional olefin comonomer in stream 112 can be controlled with the control valve in stream 112, the flow rate of diluent in stream 114 can be controlled with the control valve in stream 114, and the flow rate of catalyst in stream 116 can be controlled with the control valve in stream 116.

Olefin monomers contemplated herein typically include olefin compounds having from 2 to 30 carbon atoms per molecule and having at least one olefinic double bond. Acyclic, cyclic, polycyclic, terminal (a), internal, linear, branched, substituted, unsubstituted, functionalized, and non-functionalized olefins can be employed. For example, typical unsaturated compounds that can be polymerized to produce olefin polymers can include, but are not limited to, ethylene, propylene, 1-butene, 2-butene, 3-methyl-1-butene, isobutylene, 1-pentene, 2-pentene, 3-methyl-1-pentene, 4-methyl-1-pentene, 1-hexene, 2-hexene, 3-hexene, 3-ethyl-1-hexene, 1-heptene, 2-heptene, 3-heptene, the four normal octenes (e.g., 1-octene), the four normal nonenes, the five normal decenes, or combinations thereof. Cyclic and bicyclic olefins, including but not limited to, cyclopentene, cyclohexene, norbornylene, norbornadiene, and the like, also can be polymerized as described herein. Styrene also can be employed as a monomer or as a comonomer. In an embodiment, the olefin monomer can comprise a C₂-C₂₄ olefin; alternatively, a C₂-C₁₂ olefin; alternatively, a C₆-C₂₄ olefin; alternatively, a C₂-C₁₀ a-olefin; alternatively, propylene, 1-butene, 1-pentene, 1-hexene, 1-heptene, 1-octene, 1-decene, or styrene; alternatively, ethylene, propylene, 1-butene, 1-hexene, or 1-octene; alternatively, ethylene or propylene; alternatively, ethylene; or alternatively, propylene.

When a comonomer is fed to the loop slurry polymerization reactor 100, the olefin monomer can comprise, for example, ethylene or propylene, which is copolymerized with at least one comonomer. In some aspects, the olefin monomer can include ethylene and the olefin comonomer can include propylene, 1-butene, 2-butene, 3-methyl-1-butene, isobutylene, 1-pentene, 2-pentene, 3-methyl-1-pentene, 4-methyl-1-pentene, 1-hexene, 2-hexene, 3-ethyl-1-hexene, 1-heptene, 2-heptene, 3-heptene, 1-octene, 1-decene, styrene, or combinations thereof.

In aspects, the amount of olefin comonomer in the loop slurry polymerization reactor 100 can be from about 0.01 wt % to about 50 wt %; alternatively, from about 0.01 to about 40 wt %; alternatively, from about 0.1 wt % to about 35 wt %; alternatively, from about 0.5 wt % to about 20 wt %, based on the total weight of the olefin monomer and olefin comonomer in the loop slurry polymerization reactor 100.

The diluent can include any saturated hydrocarbon having 3 to 20 carbon atoms. Examples of the diluent can include, but are not limited to, propane, isobutane, n-butane, n-pentane, isopentane, neopentane, n-hexane, cyclohexane, or combinations thereof. Some loop polymerization reactions can occur under bulk conditions where no diluent is used. An example is bulk polymerization of propylene as disclosed in U.S. Pat. No. 11,180,587, which is incorporated by reference herein in its entirety.

Examples of catalysts that can be used in the polymerization of the loop slurry polymerization reactor 100 include, but are not limited to, Ziegler catalyst, Ziegler-Natta catalyst, metallocene catalyst, chromium-based catalysts, or combinations thereof. In some aspects, the catalyst can be part of a catalyst system that includes, in addition to the catalyst, a support, a co-catalyst, a carrier (e.g., any inert hydrocarbon liquid such as any of those suitable for use as diluent), or both a co-catalyst and a carrier. In additional aspects, two catalysts can be present in a dual catalyst system.

In some aspects, a dual catalyst system can comprise a first metallocene catalyst component and a second metallocene catalyst component. The first metallocene catalyst component and the second metallocene catalyst component independently can comprise, for example, a transition metal (one or more than one) from Groups IIIB-VIIIB of the Periodic Table of the Elements. In one embodiment, the first metallocene catalyst component and the second metallocene catalyst component independently system can comprise a Group III, IV, V, or VI transition metal, or a combination of two or more transition metals. The first metallocene catalyst component and the second metallocene catalyst component independently can comprise chromium, titanium, zirconium, hafnium, vanadium, or a combination thereof, or can comprise titanium, zirconium, hafnium, or a combination thereof, in other embodiments. Accordingly, the first metallocene catalyst component and the second metallocene catalyst component independently can comprise titanium, or zirconium, or hafnium, either singly or in combination.

In other aspects, the dual catalyst system can comprise a first transition metal compound, a second transition metal compound, and an activator-support. In such embodiments, the processes and systems disclosed herein are not limited to any particular transition metal-based catalyst system; thus, any transition metal-based catalyst system (one or more than one) suitable for the polymerization of an olefin monomer (and optional olefin comonomer(s)) can be employed with an activator-support. The first transition metal compound and the second transition metal compound independently can comprise, for example, a transition metal (one or more than one) from Groups IIIB-VIIIB of the Periodic Table of the Elements. In one embodiment, the first transition metal compound and the second transition metal compound independently system can comprise a Group III, IV, V, or VI transition metal, or a combination of two or more transition metals. The first transition metal compound and the second transition metal compound independently can comprise chromium, titanium, zirconium, hafnium, vanadium, or a combination thereof, or can comprise chromium, titanium, zirconium, hafnium, or a combination thereof, in other embodiments. Accordingly, the first transition metal compound and the second transition metal compound independently can comprise chromium, or titanium, or zirconium, or hafnium, either singly or in combination. In an embodiment, the first transition metal compound can produce the lower molecular weight component of the olefin polymer, and the second transition metal compound can produce the higher molecular weight component of the olefin polymer.

Various transition metal-based catalyst systems known to a skilled artisan are useful in the polymerization of olefins. These include, but are not limited to, Ziegler-Natta based catalyst systems (e.g., Ziegler-based catalyst systems), chromium-based catalyst systems, metallocene-based catalyst systems, Phillips catalyst systems, Ballard catalyst systems, coordination compound catalyst systems, post-metallocene catalyst systems, and the like, including combinations thereof.

For instance, the dual catalyst system can comprise a Ziegler-Natta based catalyst system, a chromium-based catalyst system, and/or a metallocene-based catalyst system; alternatively, a Ziegler-Natta based catalyst system; alternatively, a chromium-based catalyst system; or alternatively, a metallocene-based catalyst system. Examples of representative and non-limiting transition metal-based catalyst systems include those disclosed in the U.S. Pat. Nos. 3,887,494, 3,119,569, 4,053,436, 4,981,831, 4,364,842, 4,444,965, 4,364,855, 4,504,638, 4,364,854, 4,444,964, 4,444,962, 3,976,632, 4,248,735, 4,297,460, 4,397,766, 2,825,721, 3,225,023, 3,226,205, 3,622,521, 3,625,864, 3,900,457, 4,301,034, 4,547,557, 4,339,559, 4,806,513, 5,037,911, 5,219,817, 5,221,654, 4,081,407, 4,296,001, 4,392,990, 4,405,501, 4,151,122, 4,247,421, 4,460,756, 4,182,815, 4,735,931, 4,820,785, 4,988,657, 5,436,305, 5,610,247, 5,627,247, 3,242,099, 4,808,561, 5,275,992, 5,237,025, 5,244,990, 5,179,178, 4,855,271, 5,179,178, 5,275,992, 3,900,457, 4,939,217, 5,210,352, 5,436,305, 5,401,817, 5,631,335, 5,571,880, 5,191,132, 5,480,848, 5,399,636, 5,565,592, 5,347,026, 5,594,078, 5,498,581, 5,496,781, 5,563,284, 5,554,795, 5,420,320, 5,451,649, 5,541,272, 5,705,478, 5,631,203, 5,654,454, 5,705,579, 5,668,230, 6,300,271, 6,831,141, 6,653,416, 6,613,712, 7,294,599, 6,355,594, 6,395,666, 6,833,338, 7,417,097, 6,548,442, and 7,312,283, each of which is incorporated herein by reference in its entirety.

In some aspects, the catalyst system can comprise an activator, an activator-support, an aluminoxane compound, an organoboron or organoborate compound, an ionizing ionic compound, or combinations thereof. Examples of activators are disclosed in, for instance, U.S. Pat. Nos. 3,242,099, 4,794,096, 4,808,561, 5,576,259, 5,807,938, 5,919,983, and 8,114,946, the disclosures of which are incorporated herein by reference in their entirety. Examples of an activator-support can include fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, fluorided silica-coated alumina, sulfated silica-coated alumina, phosphated silica-coated alumina, or combinations thereof.

Co-catalysts can include, but are not limited to, metal alkyl, or organometal, co-catalysts, with the metal encompassing boron, aluminum, and the like. The dual catalyst systems provided herein can comprise a co-catalyst, or a combination of co-catalysts. For instance, alkyl boron and/or alkyl aluminum compounds often can be used as co-catalysts in such catalyst systems. Representative boron compounds can include, but are not limited to, tri-n-butyl borane, tripropylborane, triethylborane, and the like, and this include combinations of two or more of these materials. While not being limited thereto, representative aluminum compounds (e.g., organoaluminum compounds) can include, trimethylaluminum, triethylaluminum, tri-n-propylaluminum, tri-n-butylaluminum, triisobutylaluminum, tri-n-hexylaluminum, tri-n-octylaluminum, diisobutylaluminum hydride, diethylaluminum ethoxide, diethylaluminum chloride, and the like, as well as any combination thereof.

The polymer that is produced in the loop slurry polymerization reactor 100 can be an ethylene homopolymer, a propylene homopolymer, an ethylene copolymer (e.g., ethylene/1-butene, ethylene/1-hexene, or ethylene/1-octene), a propylene random copolymer, a propylene block copolymer, or combinations thereof. In some aspects, the polymer can be a low density polyethylene (LDPE), linear low density polyethylene (LLDPE), medium density polyethylene (MDPE), high density polyethylene (HDPE), or a combination thereof.

The reactor controller 150 can be embodied as a control computer device having one or more processors, one or more memory, and instructions on the memory that cause the processor(s) to receive signals from sensors, analyze the signals, and control equipment of the loop slurry polymerization reactor 100 so as to control polymerization conditions in the loop slurry polymerization reactor 100. For example, the reactor controller 150 can be embodied as a distributed control system (DCS) or a programmable logic (PLC) based system. In FIGS. 1, 2, and 3, the reactor controller 150 is operably connected to control valves in streams 110, 112, 114, and 116, to indicate that the reactor controller 150 can control the flow of olefin monomer, olefin comonomer, diluent, and catalyst into the loop slurry polymerization reactor 100 via actuation of the control valves in the streams 110, 112, 114, and 116. However, it is to be understood that the reactor controller 150 can be configured to receive signals from any number and type of sensors associated with the polymerization systems 1000, 2000, and 3000, such as flow meters, pump motors, thermocouples, pressure transducers, gas analyzers, particle size analyzers, or combinations thereof, that are connected or coupled to the loop slurry polymerization reactor 100, and to control any equipment associated with the operation of the loop slurry polymerization reactor 100.

In aspects, a gas analyzer 720 of the reactor effluent vapor composition measurement system 700 can be operably coupled to the reactor controller 150, and the reactor controller 150 can be configured to receive a signal or measurement reading from the gas analyzer 720 indicating a concentration of one or more gas components in the gas that was analyzed by the gas analyzer 720, analyze the signal, and adjust a condition in the loop slurry polymerization reactor 100 based on the signal. The gas analyzer 720 is discussed in more detail herein.

In response to receiving signals and/or data from sensors and/or analyzers (e.g., gas analyzer 720), the reactor controller 150 is configured to maintain or adjust a polymerization condition in the loop slurry polymerization reactor 100 based on the sensed signals and/or data. Polymerization conditions that can be controlled by the reactor controller 150 can include temperature (e.g., via coolant flow control through cooling jackets on the vertical segments 102), pressure, and the flow rate of various feed components (e.g., olefin monomer, olefin comonomer, diluent, catalyst, or combinations thereof) into the loop slurry polymerization reactor 100.

Some of the reaction medium can be removed from the loop slurry polymerization reactor 100 as reactor effluent. The removal can be continuous or periodic, for example. The reactor effluent can be embodied as a suspension comprising solid polymer particles in a liquid comprising the diluent, olefin monomer, and any comonomer. The reactor effluent can also include olefin monomer in a gas phase that is separate from the liquid. In aspects, reactor effluent is removed from the loop slurry polymerization reactor 100 via polymer product stream 120. The polymer product stream 120 can include a continuous take-off valve 122 to regulate the removal of reactor effluent from the loop slurry polymerization reactor 100. Because in-line analyzers of the liquid of the reactor effluent can foul, it is contemplated within the scope of this disclosure that the polymer product stream 120 contains no liquid analyzer equipment.

In aspects, reactor effluent withdrawn from the loop slurry polymerization reactor 100 may convey through the polymer product stream 120. A differential pressure between an outlet of the loop slurry polymerization reactor 100 and the product separator 300 may provide motive force to convey the reactor effluent in polymer product stream 120; alternatively, motive force can be provided or supplemented with other equipment known in the art with aid of this disclosure.

The systems 1000, 2000, and 3000 can include piping or conduit that draws a sample portion of the reactor effluent from the main effluent flow direction (i.e., in the direction of the product separator 300) to a sample flow direction that conveys the sample portion to the reactor effluent vapor composition measurement system 700. In systems 1000 and 2000, the reactor effluent can be split using a pipe tee that splits the reactor effluent into a first portion to flow in main effluent stream 121 and a second portion to flow in sample effluent stream 123. In system 3000, the reactor effluent can be split using piping that is fluidly coupled to two segments 201 of the flashline heater 200, between two of the segments 201. The reactor effluent vapor composition measurement system 700 is described in more detail herein.

In aspects, the systems 1000, 2000, and 3000 can also include a catalyst deactivation stream 124 that is connected to the polymer product stream 120 downstream of the continuous take-off valve 122 and upstream of the location where the reactor effluent is split into the first portion and the second portion. Alternatively, the catalyst deactivation stream 124 can be embodied as two streams, where one stream connects to the main effluent stream 121 and the second stream connects to the sample effluent stream 123. In such aspects, the catalyst deactivation stream 124 (embodied as two streams) is downstream of the continuous take-off valve 122 and also downstream of the location where the reactor effluent is split into the first portion and the second portion. Examples of catalyst deactivators include, but are not limited to, carbon monoxide, water, an alcohol such as methanol, ethanol, or propanol, a mixture of alcohols, or a combination thereof.

As shown in FIG. 2 and FIG. 3, the flashline heater 200 can include a plurality of segments 201 connected in series. One or more of the segments 201 of the flashline heater 200 may comprise a segment set. In embodiments, a segment set may comprise a group of the segments 201 of the flashline heater 200 which are connected in series and which may share a common parameter such as inner diameter, whether the segments are heated, or combinations thereof; alternatively, a single segment of the plurality of segments 201 may comprise a segment set which has a parameter different than other segments and/or segment sets. The flashline heater 200 operates by applying heat to the reactor effluent to convert at least some of the liquid phase to gas phase as the reactor effluent flows through the flashline heater 200 to the product separator 300. Heat can be supplied by steam that flows into and/or through heating jackets that are attached around at least part of at least some of the segments 201. While the segments 201 are illustrated in FIG. 2 and FIG. 3 as being connected end-to-end, it is also contemplated that piping of smaller diameter than the segments 201 can be fluidly connected between any two of the segments 201 that are connected in series with one another. In aspects, FIGS. 1 to 3 illustrate that an outlet stream 202 can connect an outlet of the flashline heater 200 to an inlet of the product separator 300. Alternative apsects contemplate that the outlet of the flashline heater 200 can be connected directly to an inlet of the product separator 300, without presence of stream 202. In some aspects, the phase composition of the first portion of the reactor effluent can change while the first portion flows through the flashline heater 200, e.g., the first portion of the reactor effluent can contain more gas phase immediately before entering the product separator 300 than the first portion of the reactor effluent contains when entering the flashline heater 200.

The product separator 300 is configured to receive the reactor effluent from the main effluent stream 121 or from the flashline heater 200 (e.g., via the outlet stream 202). The product separator 300 is configured to separate the reactor effluent into a vapor product portion containing hydrocarbons and light components (e.g., hydrogen, nitrogen, water vapor) and a solid product portion containing the polymer and residual hydrocarbons (e.g., unreacted comonomer, diluent) that are entrained in the polymer or otherwise residually remaining with the polymer. The vapor product portion can flow from the product separator 300 via vapor stream 302, and the solid product portion can flow from the product separator 300 via solids stream 304. The vapor stream 302 and the solids stream 304 can include conduits or pipes that are connected to a respective vapor outlet and solids outlet of the product separator 300.

In aspects, the product separator 300 may be embodied as a flash tank, a flash vessel, a flash chamber, a cyclone, a high efficiency cyclone, or a centrifuge. Generally, the product separator 300 can be a hollow vessel having at least a portion thereof in a conical shape. The top of the product separator 300 can have a diameter that is greater than a diameter of the bottom of the separator 300. In aspects where the product separator 300 is a cyclone separator, the cone angle of the cyclone separator can be about 45° to about 80°; alternatively, about 50° to about 75°; alternatively, about 60° to about 65°; alternatively, about 45° to about 60°; alternatively, about 60° to about 70°; alternatively, about 70° to about 80°.

In aspects, the product separator 300 may additionally comprise any equipment associated with the product separator 300, such as control devices (e.g., a PID controller) and measurement instruments (e.g., thermocouples), and level control and measurement devices.

In aspects, the product separator 300 is a single vessel. In other aspects, the product separator 300 can include two vessels connected in series. For example, a first vessel of the product separator 300 may be embodied as a flash tank, a flash vessel, a flash chamber, a cyclone, a high efficiency cyclone, or a centrifuge having the aspects described herein; and the second vessel of the product separator 300 can be embodied as another flash tank, flash vessel, flash chamber, cyclone, high efficiency cyclone, or centrifuge, that is connected in series and downstream of the first vessel. In such aspects, the inlet of the first vessel can be configured to receive the reactor effluent, and the polymer outlet of the first vessel through which the solid polymer flows may be directly connected to an inlet of the second vessel; alternatively, the polymer outlet of the first vessel may be coupled to the inlet of the second vessel via a conduit or pipe. The pipe or conduit that connects the two vessels of the product separator 300 may include a continuous valve of similar configuration of continuous take-off valve 122 that is configured to continuously allow flow of polymer (e.g., containing residual hydrocarbons as described herein) from the first vessel to the second vessel where further separation of residual hydrocarbons from the polymer can occur, before flowing the polymer from the polymer outlet of the second vessel to the purge column 400.

In some aspects where the product separator 300 includes two vessels connected in series, the first vessel can operate at a high pressure (e.g., a pressure in a range of from 100 psig to 400 psig (0.861 MPag to 2.758 MPag)) and the second vessel can operate at a low pressure (e.g., a pressure in a range of from 0 psig to 45 psig (0 MPag to 0.310 MPag)). In such aspects, the first vessel can be a high pressure flash tank or high pressure flash chamber, and the second vessel can be a high pressure flash tank or a high pressure flash chamber. The vapor outlet of each vessel can connect to the vapor stream 302, and the solids outlet of each vessel can connect to the solids stream 304.

In one or more embodiments, the vapor product portion recovered from the product separator 300 may comprise unreacted olefin monomer, unreacted olefin comonomer, diluent, or combinations thereof. Examples of compounds that can be present in the vapor product portion include hydrogen, nitrogen, methane, ethylene, ethane, propylene, propane, butane, isobutane, pentane, hexane, 1-hexene, or combinations thereof. In an embodiment, the olefin (e.g., ethylene) may be present in a range of from about 0.1 wt % to about 15 wt %; alternatively, from about 1.5 wt % to about 5 wt %; alternatively, from about 2 wt % to about 4 wt % based on a total weight of the vapor product portion. The diluent (e.g., isobutane) may be present in a range of from about 80 wt % to about 98 wt %; alternatively, from about 92 wt % to about 96 wt %; alternatively, about 95 wt % based on a total weight of the vapor product portion. For the product separator 300 embodied as a high pressure flash tank or high pressure flash chamber as the only vessel or first vessel of the product separator 300, it has been found that the vapor product portion does not have a composition that accurately reflects the liquid composition in the reactor. Thus, aspects of this disclosure contemplated that there is no gas analyzer connected or coupled to the product separator 300 or to the vapor stream 302, which would determine a composition of the vapor product portion. Instead, disclosed herein is the reactor effluent vapor composition measurement system 700 for determining the composition of a vapor sample portion of the reactor effluent recovered from a low pressure flash separation of the reactor effluent. The reactor effluent vapor composition measurement system 700 is described in more detail below.

The purge column 400 is coupled to the product separator 300 via the solids stream 304. The purge column 400 is configured to receive the polymer from the solids stream 304, and is configured to flow a purge gas through the polymer particles to remove at least a portion of any residual hydrocarbons (e.g., unreacted olefin monomer, any optional olefin comonomer, any diluent, or combinations thereof) entrained or otherwise remaining within the polymer. Purge gas stream 406 can be connected to an inlet of the purge column 400, e.g., on the side near the bottom of the purge column 400 and configured to provide a purge gas (e.g., nitrogen; an inert hydrocarbon such as ethane, propane, n-butane, isobutane, pentane, or mixtures thereof; ethylene, propylene, or any other hydrocarbon) to the purge column 400. The purge column 400 can be operated at appropriate conditions (e.g., temperature, pressure, inert gas flow rate, polymer residence time) such that the inert gas flows through the polymer particles present in the purge column 400, removes entrained hydrocarbon(s) from the polymer particles, moves upwardly through the purge column 400 with the removed hydrocarbon(s), and exits the purge column 400 along with the previously entrained hydrocarbon(s) in a degas stream 402. The degassed polymer can be recovered via polymer stream 404. The purge gas stream 406, the degas stream 402, and the polymer stream 404 may each flow in respective conduits or pipes that are connected to the purge column 400.

The purge column 400 can be configured for plug flow of polymer product from top to bottom of the vessel. The residence time of polymer in the purge column 400 can be at least 10 minutes; alternatively, at least 30 minutes; alternatively, about 1 hr; alternatively, from about 1 hr to about 6 hrs; alternatively, from about 1 hr to about 8 hrs; alternatively, from about 1 hr to about 16 hrs. The operating pressure of the purge column 400 can be a vacuum pressure, atmospheric pressure, or greater than atmospheric pressure. In a particular aspect, the pressure of the purge column 400 can be a pressure in the range of from about 0 psia to about 50 psia (about-0.101 MPaa to about 0.345 MPaa).

While one purge column 400 is illustrated in FIGS. 1 to 3, it is contemplated that purging/degassing can take place in two or more purge columns operated in parallel and having the same configuration as purge column 400, with the purge gas stream 406 feeding to each purge column, degas streams combining into degas stream 402, and polymer streams combining into polymer stream 404. Alternatively, it is contemplated that degassing can take place in two or more purge columns connected in series and having the same configuration as purge column 400, with the purge gas stream 406 feeding to each purge column, degas streams combining into degas stream 402, a polymer stream of the first purge column feeding to the second purge column, and so on, until the final purge column produces the polymer stream 404. Alternatively still, it is contemplated that degassing can take place in multiple purge column trains operated in parallel or in series, where each train contains two or more purge columns connected in series. As with other aspects, the purge gas stream 406 can be configured to feed to each purge column in the trains, each purge column can produce a degas stream that combines with other degas streams to form the degas stream 402, and the final purge column of each train having a polymer stream that combines with the other polymer streams of the final purge column in other trains to form polymer stream 404.

In aspects, the purge column 400 can be configured to receive polymer solids from the sample separator 710 of the reactor effluent vapor composition measurement system 700, e.g., via stream 714, which is described in more detail herein.

The monomer diluent recovery unit (MDRU) 500 can include one or more distillation columns, referred to as a lights column and a heavies column, connected in series and in any order. The heavies column is configured to produce a comonomer stream 506 comprising unreacted olefin comonomer. The lights column is configured to separate a feed into an unreacted olefin monomer stream 502 comprising olefin monomer and a diluent stream 504 comprising the diluent. An optional olefin-free diluent stream can be produced by the lights column, where the diluent stream 504 is a recycle grade diluent containing some unreacted olefin monomer. Each column can have any number and configuration of trays, baffles, packing, or other structure(s) configured to perform distillation of the components of the vapor stream 302 into the unreacted olefin monomer stream 502, diluent stream 504, and comonomer stream 506. It is contemplated that various equipment associated with monomer and diluent recovery systems (e.g., valves, pumps, accumulators, piping, reboilers, condensers, heaters, compressors, control systems, safety equipment, and the like), while not shown for purposes of clarity, can be included in the monomer diluent recovery unit 500 according to techniques known in the art with the aid of this disclosure.

The lights column can be operated at conditions (e.g., temperature, pressure, number of trays, reflux rate, heating rate, and other parameters for controlling the operation of a distillation column) suitable to recover the unreacted olefin monomer and gases lighter than olefin monomer (e.g., nitrogen, hydrogen, oxygen, water vapor, or combinations thereof) in an overhead stream which is the unreacted olefin monomer stream 502 and diluent in a side stream or bottom stream which is the diluent stream 504. For example, the lights column can be operated at a temperature gradient from bottom to top in a range of from about 50° C. (122° F.) to about 5° C. (41° F.); alternatively, from about 40° C. (104° F.) to about 5° C. (41° F.); alternatively, from about 30° C. (86° F.) to about 5° C. (41° F.), and a pressure in a range of from 0.101 MPaa (14.7 psia) to about 3.64 MPaa (527.9 psia), alternatively, from about 0.108 MPaa (15.7 psia) to about 2.40 MPaa (348 psia), alternatively, from about 0.586 MPaa (85 psia) to about 2.00 MPaa (290 psia).

The heavies column can be operated at conditions (e.g., temperature, pressure, number of trays, reflux rate, heating rate, and other parameters for controlling the operation of a distillation column) suitable to recover heavy hydrocarbons in the unreacted comonomer stream 506 and components lighter than the comonomer in an overhead stream which can be fed to the lights column. For example, the heavies column can be operated at a temperature gradient in a range of from about 15° C. (59° F.) to about 233° C. (451.4° F.), alternatively, from about 20° C. (68° F.) to about 200° C. (392° F.), alternatively, from about 20°° C. (68° F.) to about 180° C. (356° F.); and a pressure in a range of from about 0.101 MPaa (14.7 psia) to about 3.64 MPaa (527.9 psia), alternatively, from about 0.108 MPaa (15.7 psia) to about 2.40 MPaa (348 psia), alternatively, from about 0.586 MPaa (85 psia) to about 2.00 MPaa (290 psia).

A diluent nitrogen recovery unit (DNRU) 600 can be coupled to the purge column 400 via the degas stream 402. The diluent nitrogen recovery unit 600 can be configured to separate the degas stream 402 into an inert gas stream 602 (e.g., containing the purge gas) and a diluent stream 604 containing residual diluent any other residual hydrocarbons (e.g., comonomer). The diluent nitrogen recovery unit 600 can utilize any technique for separating the inert gas used for degassing from the residual hydrocarbons, for example, compression, distillation (e.g., utilizing cryogenic and/or vacuum conditions), absorption, membrane separation, condensation, or combinations thereof. In aspects, the inert gas stream 602 can be used as the purge gas stream 406, or can supply the inert gas as at least a portion of the purge gas stream 406.

In aspects, the diluent nitrogen recovery unit 600 can be configured to receive a portion of the vapor recovered from a sample separator 710 of the reactor effluent vapor composition measurement system 700 via stream 715, which is described in more detail herein.

In aspects, the reactor effluent that is removed from the loop slurry polymerization reactor 100 via polymer product stream 120 can be split into a first portion that flows in the main effluent stream 121 and a second portion that flows in the sample effluent stream 123. In aspects, the split occurs downstream of a location where a catalyst deactivator is injected into the reactor effluent (e.g., via stream 124). In some aspects such as those illustrated in FIG. 1, the reactor effluent is split into the first portion and the second portion upstream of the flashline heater 200. In other aspects such as those illustrated in FIG. 2, the reactor effluent is split into the first portion and the second portion between two segments 201 of the flashline heater 200 such that the main effluent stream 121 is formed in, and continues flow through, the flashline heater 200, while the sample effluent stream 123 flows from the side of the flashline heater 200.

The first portion of the reactor effluent can flow in the main effluent stream 121, optionally through the flashline heater 200 (for systems 2000 and 3000 in FIG. 2 and FIG. 3), and into the product separator 300.

The second portion of the reactor effluent can flow to the reactor effluent vapor composition measurement system 700. The reactor effluent vapor composition measurement system 700 can include a first valve 701, an isolation tube 702 having an end connected to the first valve 701, a second valve 703 connected to an opposite end of the isolation tube 702, a sample separator 710 coupled to the second valve 703 (e.g., via stream 704), a third valve 705 coupled to a solids outlet of the sample separator 710, a sensor 706 configured to sense a pressure or a level of polymer in the sample separator 710, a gas analyzer 720 coupled to a vapor outlet of the sample separator 710, and a valve controller 730 configured to actuate the first valve 701, second valve 703, and third valve 705 between respective open positions and closed positions.

The first valve 701, the second valve 703, and the third valve 705 can each be a control valve actuated by pneumatic or electronic signals and controlled by the valve controller 730. The valves 701, 703, and 705 are each configured to actuate from an open position to a closed position and from the closed position to an open position. The first valve 701, the second valve 703, and the third valve 705 can each have a flow orifice diameter independently selected to be in a range of from about 0.5 inch to about 1 inch (1.27 cm to 2.54 cm); alternatively, about 0.75 inch (1.91 cm). In aspects, the first valve 701 and the second valve 703 have the same orifice diameter. In other aspects, the orifice diameter of the second valve 703 can be smaller than the orifice diameter of the first valve 701. Each valve 701 and 703 can be actuated by a valve controller to accomplish actuation of the valves 701 and 703 as described herein. The first valve 701 can be positioned an inlet or end of the isolation tube 702, and the second valve 703 can be positioned on an outlet or opposite end of the isolation tube 702. The third valve 705 can be positions on the solids outlet of the sample separator 710 or in the solids stream 714 proximate to the solids outlet of the sample separator 710.

The isolation tube 702 can be embodied as a pipe or conduit having an inner diameter that is the same as the first valve 701 and the second valve 703 (e.g., a diameter in a range of from about 0.5 inch to about 1 inch (1.27 cm to 2.54 cm); alternatively, about 0.75 inch (1.91 cm)). In aspects, the isolation tube 702 can have an interior volume in a range of from 50 mL to 500 mL; alternatively, from 50 mL to 250 mL; alternatively, from 50 mL to 150 mL; alternatively, about 100 mL. The isolation tube 702 is configured to collect the second portion of the reactor effluent via sample effluent stream 123 and the first valve 701. In aspects, the volume of the isolation tube 702 does not disturb operation of the main portion of reactor effluent flow in stream 121.

The sample separator 710 can be embodied as a vessel configured as a flash tank or flash chamber. An inlet of the sample separator 710 can be coupled to the second valve 703 via stream 704; alternatively, the inlet of the sample separator 710 can be directly connected to the second valve 703. The sample separator 710 can be coupled to an outlet of the isolation tube 702 via the second valve 703. The sample separator 710 can be configured to separator the second portion of the reactor effluent that is received from the isolation tube 702 via the second valve 703 into a vapor sample portion and a solid sample portion.

In aspects, the sample separator 710 can include an electric heater wrapped around the vessel or a steam jacket wrapped around the vessel, to control a temperature of the sample separator 710.

In aspects, a volume of the sample separator 710 is less than 1% the volume of the product separator 300. In additional or other aspects, the volume of the sample separator 710 is from 10 to 100 times a volume of the isolation tube 702. For example, the sample separator 710 can have a volume in a range of from 500 mL to 50 L; alternatively, from 500 mL to 25 L; alternatively, from 500 mL to 15 L; alternatively, from 500 mL to 10 L; alternatively, from 500 mL to 1 L.

The sample separator 710 is configured to operate at a low pressure in a range of from 0 psig to 45 psig (0 MPag to 0.310 MPag); alternatively, from 0 psig to 35 psig (0 MPag to 0.241 MPag); alternatively, from 10 psig to 35 psig (0.0689 MPag to 0.241 MPag); alternatively, from 15 psig to 35 psig (0.103 MPag to 0.241 MPag); alternatively, from 20 psig to 35 psig (0.137 MPag to 0.241 MPag); alternatively, from 25 psig to 35 psig (0.172 MPag to 0.241 MPag); alternatively, from 30 psig to 35 psig (0.206 MPag to 0.241 MPag).

The vapor sample portion that is recovered from the reactor effluent in the sample separator 710 contains unreacted olefin monomer, diluent, and any unreacted olefin comonomer. It has been found that the vapor sample portion recovered from the sample separator 710 according to the processes and configurations disclosed herein has a composition when measured with the gas analyzer 720 that more accurately reflects the liquid composition in the loop slurry polymerization reactor 100 compared with the composition of the vapor product portion recovered from the product separator 300. The accuracy of the composition of the vapor sample portion is further improved compared with the composition of a vapor product portion obtained from the product separator 300 having an operating pressure that is a high pressure (e.g., 100 psig to 400 psig (0.861 MPag to 2.758 MPag)).

A vapor outlet of the sample separator 710 can be connected to a vapor stream 712 and coupled to the inlet of the diluent nitrogen recovery unit 600. Thus, the vapor outlet of the sample separator 710 and the vapor outlet of the purge column 400 can be coupled to the inlet of the diluent nitrogen recovery unit 600.

The vapor sample portion can flow from the sample separator 710 in the vapor stream 712. The reactor effluent vapor composition measurement system 700 is configured to split the vapor stream 712 into a first portion that flows in gas analyzer feed stream 713 to the gas analyzer 720 and a second portion that flows in stream 715 to the diluent nitrogen recovery unit 600, to a flare, or to both the diluent nitrogen recovery unit 600 and a flare. In aspects, the gas analyzer feed stream 713 can include a filter, a gas pump, or both a filter and a gas pump (e.g., of appropriate size and compatibility for the gas analyzer 720).

A solids outlet of the sample separator 710 can be connected to a solids stream 714 and coupled to the inlet of the purge column 400. The solid sample portion can flow from the sample separator 710 in the solids stream 714. The solids stream 714 is coupled to the polymer inlet of the purge column 400 or to another polymer inlet of the purge column 400. In aspects, the solids stream 714 can combine with the solids stream 304, and both the solids outlet of the sample separator 710 and the solids outlet of the product separator 300 are coupled to the inlet of the purge column 400.

To convey the polymer through the solids stream 714, the sample separator 710 can be located in the polymerization system 1000, 2000, or 3000 at a height that is above the product separator 300, such that gravity can convey solid polymer through the solids stream 714 to the purge column 400. Additionally or alternatively, the solids stream 714 can include a blower 716 coupled between the sample separator 710 and the purge column 400. The blower 716 can be configured to push a gas into the solids stream 714 that provides motive force to convey the sample solid polymer from the sample separator 710, through the solids stream 714, and to the purge column 400. In aspects, the gas of the flower can be supplied from air in the atmosphere or from nitrogen in stream 602. Alternatively still, when the product separator 300 operates at a high pressure and the vapor stream 302 is at high pressure as disclosed herein, the vapor stream 302 can be connected to the solids stream 714 such that a portion of the vapor product portion at high pressure provides motive force to convey solid polymer through the solids stream 714 to the purge column 400.

The gas analyzer 720 can be embodied as a gas chromatograph, a mass spectrometer, an infrared absorption based gas analyzer, a Raman analytical gas analyzer, or a combination thereof. The gas analyzer 720 is configured to determine a concentration of one or more gas components of the vapor sample portion. In some aspects, the gas analyzer 720 can determine a concentration of all the gas components of the vapor sample portion.

The valve controller 730 is configured to actuate the first valve 701, second valve 703, and third valve 705 between respective open positions and closed positions. The valve controller 730 can be embodied with one or more processors, one or more memory, and instructions stored on the memory that cause the processor(s) to allow or disallow signals to the valves 701, 703, and 705.

In some aspects, the valve controller 730 can actuate the first valve 701 from a closed position to an open position while the second valve 703 is in the closed position, so as to allow the portion of reactor effluent to enter the isolation tube 702. After a period of time, such as a few seconds, the valve controller 730 actuates the first valve 701 to the closed position. While actuating the first valve 701 to the closed position, or subsequent to actuating the first valve 701 to the closed position, and while the isolation tube 702 is full of a portion of the reactor effluent, the valve controller 730 actuates the second valve 703 from the closed position to the open position. The reactor effluent in the isolation tube 702 then flows into the sample separator 710 where any liquid flashes to gas phase to accompany any reaction components there were already in gas phase. The solid polymer falls downward in the sample separator 710 by way of gravity. The sensor 706 can be a pressure transducer or level sensor configured to sense a pressure or level of polymer in the sample separator 710. When the pressure or level of polymer is greater than a setpoint, the sensor 706 can send a signal to the valve controller 730, and in response, the valve controller 730 can actuate the third valve 705 from the closed position to the open position, so as to allow polymer to flow out of the sample separator 710 via solids stream 714. An example of a setpoint pressure can be 10 psig (0.689 MPag).

A process disclosed herein can include removing a reactor effluent from a loop slurry polymerization reactor 100, splitting the reactor effluent into a first portion and a second portion, flowing the first portion of the reactor effluent to a product separator 300, separating, in the product separator 300, the first portion of the reactor effluent into a vapor product portion comprising unreacted olefin monomers and diluent and a solid product portion comprising solid polymer, flowing the second portion of the reactor effluent of the loop slurry polymerization reactor 100 to a reactor effluent vapor composition measurement system 700, separating, in the reactor effluent vapor composition measurement system 700, the second portion into a vapor sample portion and a solid sample portion; and determining a concentration of a gas component in at least a portion of the vapor sample portion.

The process can additionally include, adjusting, by a reactor controller 150, a polymerization condition in the loop slurry polymerization reactor 100 based on the concentration of the gas component in the vapor sample portion.

The process can additionally include, actuating a first valve 701 of the reactor effluent vapor composition measurement system 700 to an open position while a second valve 703 of the reactor effluent vapor composition measurement system 700 is set in a closed position, filling an isolation tube 702 of the reactor effluent vapor composition measurement system 700 with the second portion of the reactor effluent while the first valve 701 is in the open position and the second valve 703 is in the closed position, actuating the first valve 701 to a closed position while the second portion of the reactor effluent is in the isolation tube 702, actuating the second valve 703 to an open position while the second portion of the reactor effluent is in the isolation tube 702 and while the first valve 701 is in the closed position, flowing the second portion of the reactor effluent from the isolation tube 702 to the sample separator 710, and actuating the second valve 703 to the closed position after the second portion flows into the sample separator 710. The process can also include actuating a third valve 705 of the reactor effluent vapor composition measurement system 700 from a closed position to an open position to allow polymer to flow from the sample separator 710 to a purge column 400.

The process can also include flowing a first portion of the vapor sample portion to the gas analyzer 720, and flowing a second portion of the vapor sample portion to a diluent nitrogen recovery unit 600 or to a flare.

In the process, the splitting can be performed downstream of a location where a catalyst deactivator is injected into the reactor effluent, upstream of a flashline heater 200, or between two segments 201 of the flashline heater 200.

The process can also include flowing the solid product portion and the solid sample portion to a purge column 400.

The process can also include flowing the solid product portion from a flash chamber of the product separator 300 to the purge column 400, and flowing the solid sample portion from the sample separator 710 to the purge column 400.

### Additional Description

Processes and system have been described. The present application is also directed to the subject-matter described in the following numbered paragraphs (referred to as “para” or “paras”):

Para 1. A process comprising: removing a reactor effluent from a loop slurry polymerization reactor; splitting the reactor effluent into a first portion and a second portion; flowing the first portion of the reactor effluent to a product separator; separating, in the product separator, the first portion of the reactor effluent into a vapor product portion comprising unreacted olefin monomers and diluent and a solid product portion comprising solid polymer; flowing the second portion of the reactor effluent of the loop slurry polymerization reactor to a reactor effluent vapor composition measurement system; separating, in the reactor effluent vapor composition measurement system, the second portion into a vapor sample portion and a solid sample portion; and determining a concentration of a gas component in at least a portion of the vapor sample portion.

Para 2. The process of Para 1, further comprising: adjusting a polymerization condition in the loop slurry polymerization reactor based on the concentration of the gas component in the vapor sample portion.

Para 3. The process of Para 1 or 2, wherein the reactor effluent vapor composition measurement system includes: an isolation tube configured to collect the second portion of the reactor effluent; and a sample separator coupled to an outlet of the isolation tube and configured to separate the second portion of the reactor effluent into the vapor sample portion and the solid sample portion.

Para 4. The process of Para 3, wherein the reactor effluent vapor composition measurement system further comprises a first valve positioned on an inlet of the isolation tube and a second valve positioned on the outlet of the isolation tube.

Para 5. The process of Para 4, further comprising: actuating the first valve to an open position while the second valve is set in a closed position; filling the isolation tube with the second portion of the reactor effluent while the first valve is in the open position and the second valve is in the closed position; actuating the first valve to a closed position while the second portion of the reactor effluent is in the isolation tube; actuating the second valve to an open position while the second portion of the reactor effluent is in the isolation tube and while the first valve is in the closed position; flowing the second portion of the reactor effluent from the isolation tube to the sample separator; and actuating the second valve to the closed position after the second portion flows into the sample separator.

Para 6. The process of any one of Paras 1 to 5, wherein the product separator is configured to receive the first portion of the reactor effluent, wherein the reactor effluent vapor composition measurement system comprises a sample separator configured to receive the second portion of the reactor effluent, wherein an operating pressure of the product separator is in a range of from about 100 psig to about 400 psig (0.861 MPag to 2.758 MPag), wherein an operating pressure of the sample separator is in a range of from about 0 psig to about 45 psig (0 MPag to 0.310 MPag).

Para 7. The process of any one of Paras 1 to 6, wherein the concentration of the gas component is determined by a gas analyzer comprising a gas chromatograph, a mass spectrometer, an infrared absorption based gas analyzer, a Raman analytical gas analyzer, or a combination thereof.

Para 8. The process of Para 7, further comprising: flowing a first portion of the vapor sample portion to the gas analyzer; and flowing a second portion of the vapor sample portion to a diluent nitrogen recovery unit or to a flare.

Para 9. The process of any one of Paras 1 to 8, wherein the splitting is performed downstream of a location where a catalyst deactivator is injected into the reactor effluent.

Para 10. The process of Para 9, wherein the splitting is performed upstream of a flashline heater or between two segments of the flashline heater.

Para 11. The process of any one of Paras 1 to 10, further comprising: flowing the solid product portion and the solid sample portion to a purge column.

Para 12. The process of any one of Paras 1 to 11, wherein the product separator comprises a high pressure flash chamber followed by a low pressure flash chamber, wherein the reactor effluent vapor composition measurement system comprises a sample separator, the process further comprising: flowing the solid product portion from the low pressure flash chamber to a purge column; and flowing the solid sample portion from the sample separator to the purge column.

Para 13. The process of any one of Paras 1 to 12, wherein no polymerization reactor is located downstream of the loop slurry polymerization reactor.

Para 14. A polymerization system comprising: a loop slurry polymerization reactor configured to polymerize olefin monomers to form a solid polymer; a polymer product stream connected to an outlet of the loop slurry polymerization reactor; a product separator coupled to the polymer product stream; and a reactor effluent vapor composition measurement system coupled to the polymer product stream at a first location in the polymer product stream that is upstream of the product separator with respect to a main direction of flow of reactor effluent through the polymer product stream.

Para 15. The polymerization system of Para 14, wherein the reactor effluent vapor composition measurement system includes: an isolation tube configured to collect a portion of the reactor effluent; and a sample separator coupled to an outlet of the isolation tube and configured to separate the portion of the reactor effluent into a vapor sample portion and a solid sample portion.

Para 16. The polymerization system of Para 15, wherein the reactor effluent vapor composition measurement system further comprises a first valve positioned on an inlet of the isolation tube and a second valve positioned on the outlet of the isolation tube.

Para 17. The polymerization system of Para 15 or 16, further comprising: a gas analyzer coupled to a vapor outlet of the sample separator.

Para 18. The polymerization system of any one of Paras 15 to 17, further comprising: a purge column coupled to a solids outlet of the product separator; wherein a solids outlet of the sample separator is coupled to an inlet of the purge column, wherein a solids outlet of the product separator is coupled to the inlet of the purge column.

Para 19. The polymerization system of Para 18, further comprising: a diluent nitrogen recovery unit coupled to a vapor outlet of the purge column and optionally coupled to a vapor outlet of the sample separator.

Para 20. The polymerization system of Para 18 or 19, further comprising: a blower coupled between the sample separator and the purge column, wherein the blower is configured to convey a sample solid polymer from the sample separator to the purge column.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A process comprising:
removing a reactor effluent from a loop slurry polymerization reactor;
splitting the reactor effluent into a first portion and a second portion;
flowing the first portion of the reactor effluent to a product separator;
separating, in the product separator, the first portion of the reactor effluent into a vapor product portion comprising unreacted olefin monomers and diluent and a solid product portion comprising solid polymer;
flowing the second portion of the reactor effluent of the loop slurry polymerization reactor to a reactor effluent vapor composition measurement system;
separating, in the reactor effluent vapor composition measurement system, the second portion into a vapor sample portion and a solid sample portion; and
determining a concentration of a gas component in at least a portion of the vapor sample portion.

2. The process of claim 1, further comprising:
adjusting a polymerization condition in the loop slurry polymerization reactor based on the concentration of the gas component in the vapor sample portion.

3. The process of claim 1, wherein the reactor effluent vapor composition measurement system includes:
an isolation tube configured to collect the second portion of the reactor effluent; and
a sample separator coupled to an outlet of the isolation tube and configured to separate the second portion of the reactor effluent into the vapor sample portion and the solid sample portion.

4. The process of claim 3, wherein the reactor effluent vapor composition measurement system further comprises a first valve positioned on an inlet of the isolation tube and a second valve positioned on the outlet of the isolation tube.

5. The process of claim 4, further comprising:
actuating the first valve to an open position while the second valve is set in a closed position;
filling the isolation tube with the second portion of the reactor effluent while the first valve is in the open position and the second valve is in the closed position;
actuating the first valve to a closed position while the second portion of the reactor effluent is in the isolation tube;
actuating the second valve to an open position while the second portion of the reactor effluent is in the isolation tube and while the first valve is in the closed position;
flowing the second portion of the reactor effluent from the isolation tube to the sample separator; and
actuating the second valve to the closed position after the second portion flows into the sample separator.

6. The process of claim 1, wherein the product separator is configured to receive the first portion of the reactor effluent, wherein the reactor effluent vapor composition measurement system comprises a sample separator configured to receive the second portion of the reactor effluent, wherein an operating pressure of the product separator is in a range of from about 100 psig to about 400 psig (0.861 MPag to 2.758 MPag), wherein an operating pressure of the sample separator is in a range of from about 0 psig to about 45 psig (0 MPag to 0.310 MPag).

7. The process of claim 1, wherein the concentration of the gas component is determined by a gas analyzer comprising a gas chromatograph, a mass spectrometer, an infrared absorption based gas analyzer, a Raman analytical gas analyzer, or a combination thereof.

8. The process of claim 7, further comprising:
flowing a first portion of the vapor sample portion to the gas analyzer; and
flowing a second portion of the vapor sample portion to a diluent nitrogen recovery unit or to a flare.

9. The process of claim 1, wherein the splitting is performed downstream of a location where a catalyst deactivator is injected into the reactor effluent.

10. The process of claim 9, wherein the splitting is performed upstream of a flashline heater or between two segments of the flashline heater.

11. The process of claim 1, further comprising:
flowing the solid product portion and the solid sample portion to a purge column.

12. The process of claim 1, wherein the product separator comprises a high pressure flash chamber followed by a low pressure flash chamber, wherein the reactor effluent vapor composition measurement system comprises a sample separator, the process further comprising:
flowing the solid product portion from the low pressure flash chamber to a purge column; and
flowing the solid sample portion from the sample separator to the purge column.

13. The process of claim 1, wherein no polymerization reactor is located downstream of the loop slurry polymerization reactor.

14. A polymerization system comprising:
a loop slurry polymerization reactor configured to polymerize olefin monomers to form a solid polymer;
a polymer product stream connected to an outlet of the loop slurry polymerization reactor;
a product separator coupled to the polymer product stream; and
a reactor effluent vapor composition measurement system coupled to the polymer product stream at a first location in the polymer product stream that is upstream of the product separator with respect to a main direction of flow of reactor effluent through the polymer product stream.

15. The polymerization system of claim 14, wherein the reactor effluent vapor composition measurement system includes:
an isolation tube configured to collect a portion of the reactor effluent; and
a sample separator coupled to an outlet of the isolation tube and configured to separate the portion of the reactor effluent into a vapor sample portion and a solid sample portion.

16. The polymerization system of claim 15, wherein the reactor effluent vapor composition measurement system further comprises a first valve positioned on an inlet of the isolation tube and a second valve positioned on the outlet of the isolation tube.

17. The polymerization system of claim 15, further comprising:
a gas analyzer coupled to a vapor outlet of the sample separator.

18. The polymerization system of claim 15, further comprising:
a purge column coupled to a solids outlet of the product separator;
wherein a solids outlet of the sample separator is coupled to an inlet of the purge column, wherein a solids outlet of the product separator is coupled to the inlet of the purge column.

19. The polymerization system of claim 18, further comprising:
a diluent nitrogen recovery unit coupled to a vapor outlet of the purge column and optionally coupled to a vapor outlet of the sample separator.

20. The polymerization system of claim 18, further comprising:
a blower coupled between the sample separator and the purge column, wherein the blower is configured to convey a sample solid polymer from the sample separator to the purge column.
